(19) United States
(12) Patent Application Publication
(10) Pub. No.: US 2017/0316012 A1
(43) Pub. Date: Nov. 2, 2017

(54) SYSTEMS AND METHODS FOR RANKING ELECTRONIC CONTENT USING TOPIC MODELING AND CORRELATION

(71) Applicant: DynAgility LLC, Herndon, VA (US)

(72) Inventors: Stephen GLANOWSKI, Great Falls, VA (US); Randall DAVIS, Oak Hill, VA (US)

(73) Assignee: DynAgility LLC, Herndon, VA (US)

(21) Appl. No.: 15/499,175

(22) Filed: Apr. 27, 2017

Related U.S. Application Data
(60) Provisional application No. 62/329,570, filed on Apr. 29, 2016.

(51) Int. Cl. G06F 17/30; G06N 99/00

(52) U.S. Cl. CPC G06F 17/3053; G06F 17/30554; G06N 99/005

(57) ABSTRACT

Systems and methods are disclosed for ranking electronic content using a trained topic model to correlate a collection of source content to externally specified target content. Unstructured content is converted to elemental sub-content or interrelated sub-content. A probability vector for the converted externally specified content is generated by use of trained topic model. The externally specified topic probability vector is correlated against a collection of source content, previously converted to vectors that were generated using the same topic model, and a plurality of correlation methods. Rank ordered correlation results are merged to provide the user with a ranked set of source content. Source content from the ranked results can be fed back into the system to adjust the target vector.

### FIELD OF THE DISCLOSURE

The present disclosure relates to systems and methods for ranking electronic content and, more particularly, relates to systems and methods for ranking electronic content based on correlation to a topic model related to an externally specified electronic content.

### BACKGROUND OF THE DISCLOSURE

An important capability in the Internet age is prioritizing content presented to a user. Many content ranking systems rely on search keywords and the inclusion of Boolean logic. Due to synonyms, homonyms, misspellings, and word misuse, highly relevant content can be missed and low relevance content included in results. Expertise and time is often required to create an effective keyword/Boolean search. The ranking of the content returned from a keyword/Boolean search is typically based on some formulation of the keyword matching.

The development of topic modeling allows representative models to be created from a collection of electronic content. Expert system modeling requires extensive human assisted development and extensive maintenance to avoid obsolescence. Topic models are developed automatically and can be updated with the addition of newer related electronic content. Topic models can disambiguate terms across a plurality of contexts since a probabilistic measure to the context is maintained. For example, the word “cloud” can be utilized in weather context and computing context. Topic modeling eliminates the ambiguity of these two uses of the word “cloud” by probabilistically maintaining each with its proper context.

### SUMMARY OF THE DISCLOSURE

This disclosure relates to the ranking of electronic content correlated to externally specified electronic content. One embodiment of this disclosure is receiving an externally specified ideal document; converting the document into words or word relations; using a topic model trained in the domain of interest to generate a document-topic vector; using a plurality of correlation methods to evaluate similarity to another collection of documents processed by the same document conversion method and topic model; combining correlation results to generate a rank ordered list to present to a user.

### BRIEF DESCRIPTION OF THE DRAWINGS

FIG. 1 is a flowchart illustrating the overall system architecture for ranking electronic content according to an embodiment of the present disclosure.

FIG. 2 is a depiction of a block diagram of a computer system where particular embodiments of the disclosure may be implemented.

FIG. 3 is a flowchart illustrating the generation of the training topic term matrix, training content-topic matrix and training topic model inferencer according to an embodiment of the present disclosure.

FIG. 4 is a flowchart illustrating the generation of the source content-topic matrix using the training topic model inferencer according to an embodiment of the present disclosure.

FIG. 5 is a flowchart illustrating the generation of the target content-topic target matrix using the training topic model inferencer according to an embodiment of the present disclosure.

FIG. 6 is a flowchart illustrating the generation of the source content-topic vector database from the source content-topic matrix according to an embodiment of the present disclosure.

FIG. 7 is a flowchart illustrating the generation of the target content-topic vector database from the target content-topic matrix according to an embodiment of the present disclosure.

FIG. 8 is a flowchart illustrating the generation of the correlation results database from the source content-topic vector database and the target content-topic vector database according to an embodiment of the present disclosure.

FIG. 9 is a flowchart illustrating the generation of the ranking results database from the correlation results database according to an embodiment of the present disclosure.

FIG. 10 is a flowchart illustrating the incorporation of user feedback according to an embodiment of the present disclosure.

FIG. 11 is an example topic-term matrix showing example topic descriptions and the usage of bag-of-words tokens according to an embodiment of the present disclosure.

FIG. 12 is an example graph showing topic probabilities of an example document using the topic-term matrix according to an embodiment of the present disclosure.

FIG. 13 is an example graph showing topic probabilities of a second example document using the topic-term matrix according to an embodiment of the present disclosure.

FIG. 14 is an example content ranking showing the combining of correlation results according to an embodiment of the present disclosure.

FIG. 15 is an example training corpus showing example input descriptions and the usage of bag-of-words tokens according to an embodiment of the present disclosure.

FIG. 16 is an example training content-topic matrix showing example content-topic results and the usage of bag-of-words tokens according to an embodiment of the present disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples. Furthermore, while example contexts in which the disclosure can be practiced are provided, they are not meant to limit the scope of the disclosure to those contexts.

This section describes systems and methods for ranking electronic content using topic modeling and correlation. The term “content” refers to, but is not limited to, text, photos, audio, video and other electronic content. The term “user” refers to, but is not limited to, humans, computing devices, machines, networks, or anything capable of consuming the output of said systems and methods.

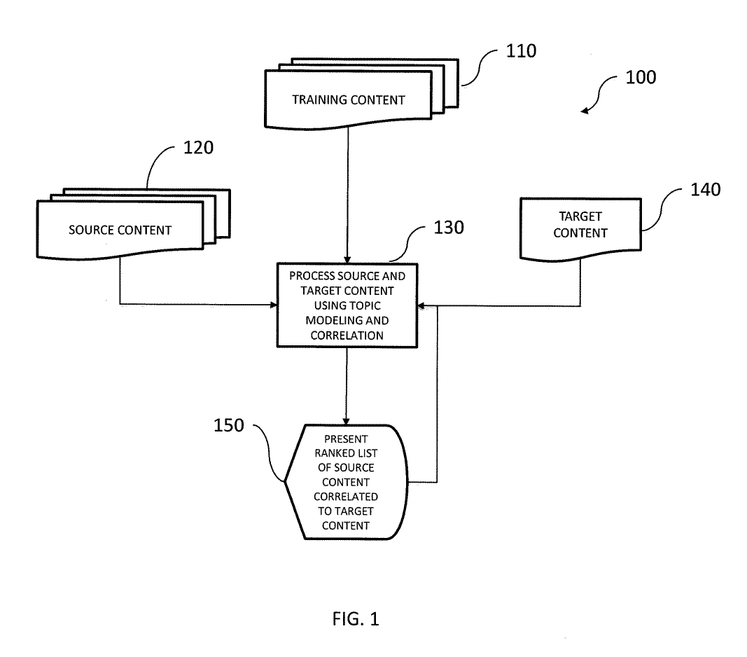

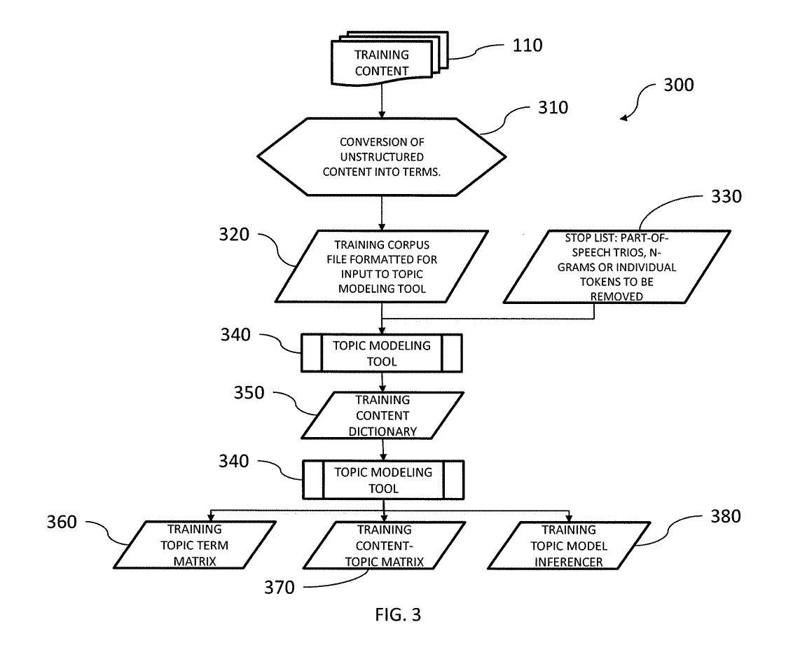

FIG. 1 presents the overall architecture for a system 100 for ranking electronic content using topic modeling and correlation. System 100 illustrates several input flows including: training content 110, source content 120, target content 140; and also illustrates content processing 130 and presented ranked content 150. User feedback can be received from the presentation of the ranked list 150 back into the content processing 130. Methods for the content processing 130 of the content are discussed in more detail below, such as the processing of training content 110, described with respect to the method 300 illustrated in FIG. 3.

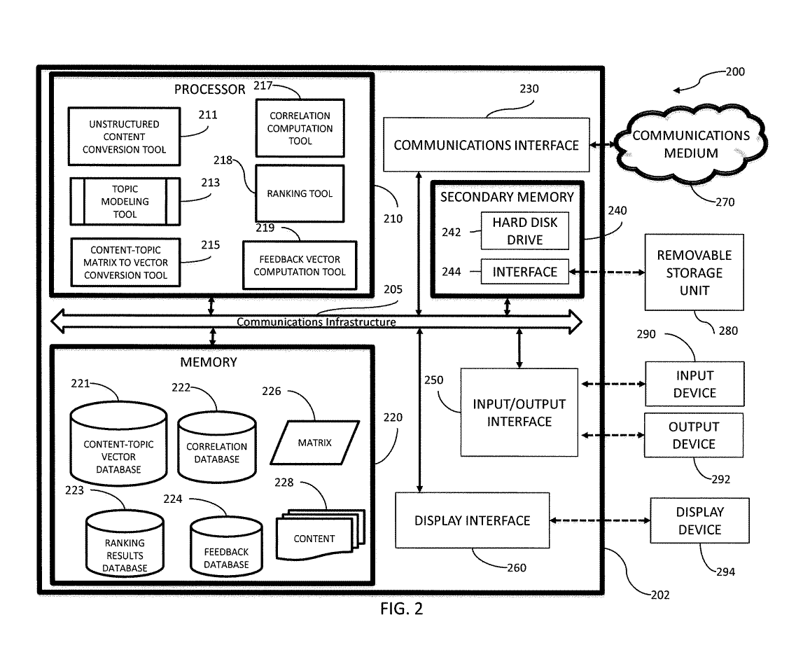

FIG. 2 illustrates an example computer system 200 used to implement at least one embodiment of the present disclosure. The computing system 200 may comprise a computing device 202. The computing device 202 may be a standalone computer or a network of computers including, for example, desktop computers, laptop computers, servers, tablet computers, personal digital assistants, handheld computing devices, cellular telephone, smart phone, smart watch, smart television, wearable computing device, implantable computing device, virtual reality headset, and the like. The computing device 202 may include at least one processor 210, memory 220, communications infrastructure 205, a communications interface 230, secondary memory 240, an input/output interface 250 and a display interface 260. The computing device may receive external content from the communications medium 270 through the communications interface 230, removable storage unit 280 through the secondary memory 240 interface 244 or input device 290 through the input/output interface 250.

The computing device 202 may contain memory 220 and secondary memory 240 to store databases 221, 222, 223, 224, matrices 226, and content 228. Depending on the specific configuration and computing device, the memory 220 may consist of volatile, non-volatile, and/or remote memory. Volatile memory, for example, may be dynamic RAM (DRAM) and/or static RAM (SRAM). Non-volatile memory, for example, may be ROM, PROM, EPROM, EEPROM, flash memory, solid-state storage, magnetic tape, hard disk drive, optical disk drive, etc. Remote memory, for example, may be cloud storage, network attached storage, etc.

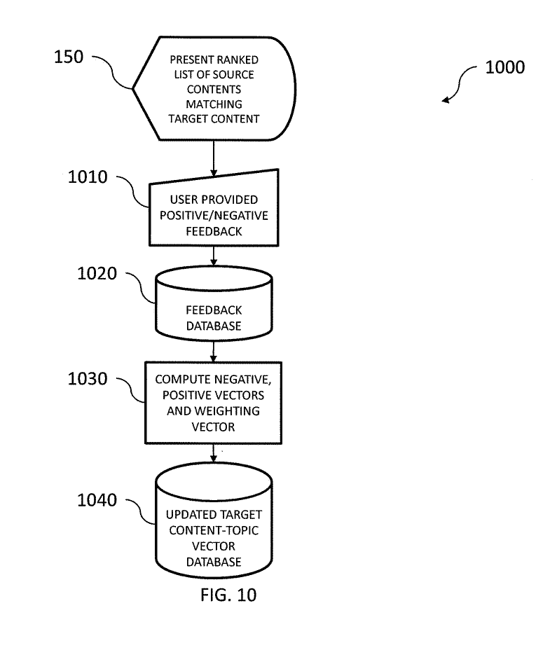

The memory 220 and/or secondary memory 240 may store a content-topic vector database 221. There are three content-topic vector databases 221 described in the present disclosure: source content-topic vector database 630, target content-topic vector database 720, and an updated target content-topic vector database 1040, each described in more detail below. Content-topic vector database 221 may be configured to store content-topic vectors related to the associated type of content (e.g., source content 120), where a content-topic vector may be a vector in numeric order of the topics for each line of the respective content. The memory 220 and/or secondary memory 240 may also be configured to store a correlation database 222. The correlation results database 850, discussed in more detail below, is one correlation database 222 described in the present disclosure. A correlation database 222 may store, for instance, results of correlations performed using the methods discussed herein, such as correlations between source content-topic vectors and target content-topic vectors (e.g., stored in respective content-topic vector database 221). The memory 220 and/or secondary memory 240 may be further configured to store a ranking results database 223. The ranking results database 970, discussed below, is one ranking results database 223 described in the present disclosure. The ranking results database 223 may be configured to store a ranking of the results of a search performed by the computing device 202 as discussed herein, such as for later use in presentation to the user or recalling during future searches for faster processing times. The memory 220 and/or secondary memory 240 may also store a feedback database 224. The feedback database 1020, illustrated in FIG. 10 and discussed in more detail below, is one feedback database 224 described in the present disclosure. The feedback database 1020 may be configured to store data associated with feedback provided by a user, such as feedback regarding search results rankings, topic keywords, etc., which may be used by the computing device 202 in future iterations of the methods discussed herein.

The memory 220 and/or secondary memory 240 may also be configured to store matrices 226. There are four matrices described in the present disclosure: the training topic term matrix 360, the training content-topic matrix 370, the source content-topic matrix 430, and the target content-topic matrix 530. Matrices 226, as discussed below, may be data files or other storage mechanisms that are configured to contain rows/columns for each line of associated data. For instance, as discussed below, the training topic term matrix 360 may contain a line for each topic reporting the top words up to a threshold number, while the training content-topic matrix 370 may contain a line for each line of a training corpus file that is delimited and has an index, a label, and paired values of topic numbers. The memory 220 and/or secondary memory 240 may also store content 228. There are three types of content described in the present disclosure: training content 110, source content 120, and target content 130. Additionally, but not illustrated, the memory 220 and/or secondary memory 240 store training corpus files 320, stop lists 330, training content dictionaries 350, training topic model inferencers 380, source corpus files 410, source content dictionaries 420, target corpus files 510, target content dictionaries 520, source content-topic vectors 620, target content-topic vectors 710, target vectors 810, source vectors 820, correlation method results 910 and 920, and any other data utilized by the computing device 202 in performing the functions discussed herein.

The computing device 202 contains at least one processor 210 specifically configured to execute instructions to perform the methods discussed herein. The processor may be configured with multiple processors or distributed to disparate computing devices not depicted. The processor 210 may be configured to process content 228 using topic modeling and correlation to provide a ranked list of source content 150. The processor 210 may include a plurality of different modules, tools, engines, etc. for performing the functions of the computing device 202 discussed herein. For instance, the processor 210 may include an unstructured content conversion tool 211 configured to convert unstructured content from content 228 into a file format usable for a topic modeling tool 213. The processor 210 may include the topic modeling tool 213, which may be configured to process corpus files 320, 410, and 510 into dictionaries 350, 420, and 520, respectively, training topic term matrix 360, training topic model inferencer 380, and content-topic matrices 370, 430, and 530, as discussed in more detail below. The processor 210 may also include a content-topic matrices to vector conversion tool 215 converting content-topic matrices 430 and 530 into content-topic vectors 620 and 710, respectively, as discussed in more detail below.

The processor 210 may also include a correlation computation tool 217, which may be configured to compute correlations correlating target vectors 810 and source vectors 820 into results, such as may be stored in a correlation database 22 (e.g., the correlation results database 850). The processor 210 may further include a ranking tool 218 configured to compute rankings, such as by combining correlation results (e.g., correlation results 910 and 920) into ranking results stored in a ranking results database 223 (e.g., the ranking results database 970). The processor 210 may also include a feedback vector computation tool 219, which may be configured to compute feedback vectors by taking user feedback (e.g., user feedback 1010) from a feedback database 224 (e.g., the feedback database 1020) and compute negative, positive, and weighting vectors, which may be used to update the vectors stored in a content-topic vector database 221.

The computer system 200 may be configured to present ranked content results to a user through the display interface 260 to the display device 294, through the input/output interface 250 to the output device 292, through the communications interface 230 to the communications medium 270. Ranked content may be presented to a user in response to a search request, such as may be submitted via the input device 290 and received by the computing device 202 using the input/output interface 250. The communications medium 270, removable storage unit 280, the input device 290, the output device 292 and the display device 294 may be connected to the computing device 130 via wired connection, wireless connection, or any combination.

FIG. 3 illustrates a method 300 for processing training content 110 using a topic modeling tool 340 to create a training topic term matrix 360, a training content-topic matrix 370, and a training topic model inferencer 380. Training content 110 must first be converted into a form usable by the topic modeling tool 340. The conversion of unstructured content (e.g., as performed by the unstructured content conversion tool 211 of the computing device 202) into terms 310, may be effectively embodied by several methods including but not limited to: converting text to individual word tokens, also known as the bag-of-words approach; converting text to text pairings by taking two or more consecutive words and joining them together, also known as n-grams; using a part-of-speech tagger to parse text and generate part-of-speech trios. In general, content conversion takes unstructured content and produces a file of terms 320. The word “term” generically references word tokens, n-grams, part-of-speech tags or other derived element from the conversion process. One embodiment of the training corpus file 320 may contain an index number followed by a delimiter, content name, delimiter and a list of terms of each training content 110.

The training corpus file 320 and a stop list 330 are received as input by the topic modeling tool 340. A stop list is not a required component, but does greatly improve the quality and performance of the topic model. The format of the stop list 330 should match that of the training corpus file 320. Restated, if text tokens are used in the training corpus file 320 then stop list 330 must consist of text tokens. If part-of-speech trios are used in the training corpus file 320 then part-of-speech trios must be used in the stop list 330. The stop list 330 is used to help ensure sufficient differentiation between and among topics. For example, stop list elements for a bag-of-words approach are determiners such as the articles “the”, “a”, and “an” or demonstratives “this” and “that.”

As illustrated in FIG. 3, the topic modeling tool 340 is used to generate a training content dictionary 350. The topic modeling tool 340 generates a training content dictionary 350 by extracting all unique sub-content from the entirety of the training corpus file 320 excluding stop list 330 elements. The training content dictionary 350 thereby defines the sub-content vocabulary used by subsequent processes 400 and 500. Example embodiments of a topic modeling tool 340 are the University of Massachusetts at Amherst's machine learning for language toolkit (MALLET), Radim Rehurek's gensim and Apache Spark's LDA.

The topic modeling tool 340 receives the training content dictionary 350 and generates two required outputs: a training content-topic matrix 370; and a training topic model inferencer 380; and one optional output, a training topic term matrix 360. The topic modeling tool 340 can be configured to produce one to many topics. Topic modeling tools are often seeded randomly and will produce different results between different separate computations under the same conditions. The topic modeling tool 340 iterates over the training corpus file 320 calculating the probability that sub-content are observed within the same line of the training corpus file 320. Upon the completion of the training process, one or more topics are produced that are defined by sub-content that have been repeatedly observed together within the training corpus file 320.

The training topic term matrix 360 is a file containing a line for each topic reporting the top words up to a threshold number. The threshold number of words reported is provided as a parameter to the topic modeling tool 340. The training topic term matrix 360 is not required for the generation of the ranked content list 150. The information found in the file can improve usability by utilizing it for topic labeling. Derived components can be used to label each topic in addition to or in lieu of a topic number. The presentation of the derived component labels is intended to provide more insight into the topics than the numeric label.

The training content-topic matrix 370 is a file containing a line for each line of the training corpus file 320. The training content-topic matrix 370 is delimited and has an index, a label, and paired values of topic numbers and probabilities. The probabilities quantify the chance that the topic belongs to that line of training content. The number of topics presented is determined by a parameter provided to the topic modeling tool 340.

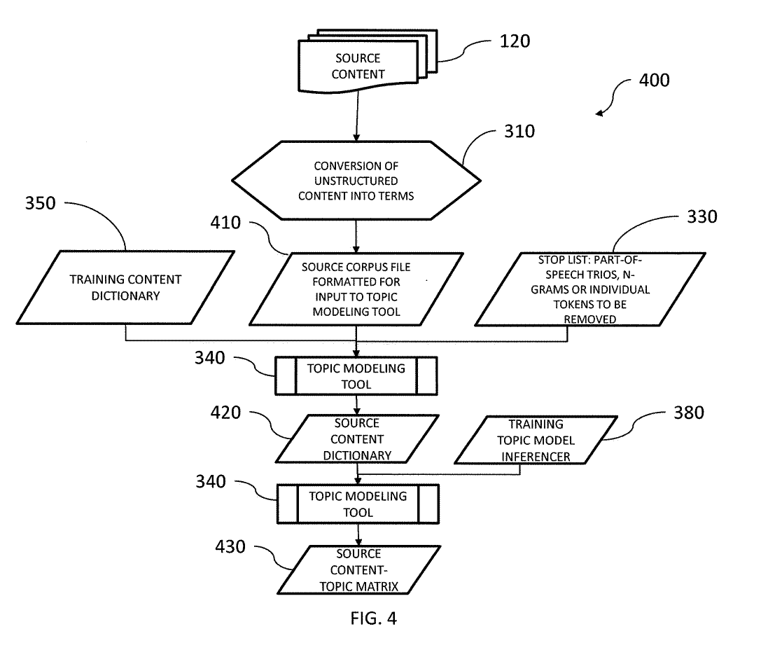

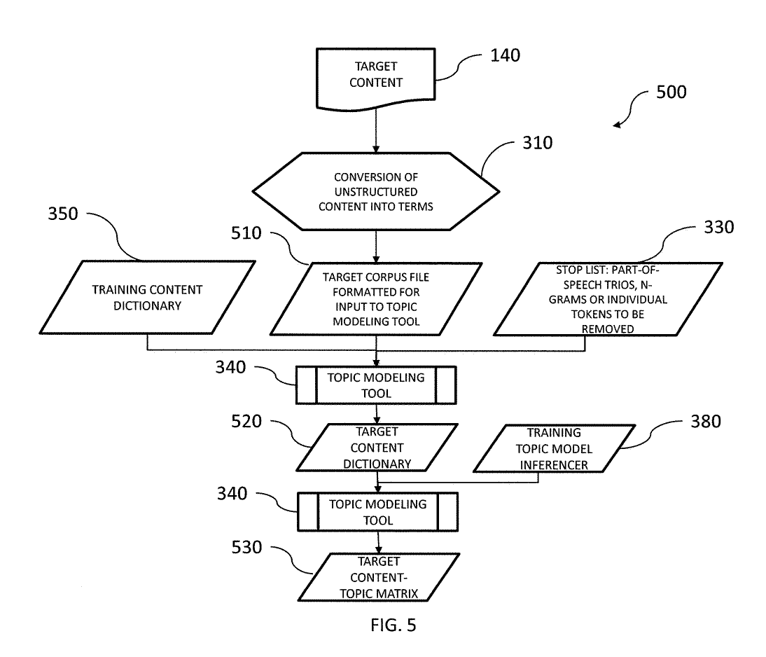

The training topic model inferencer 380 is a binary output file used to infer the topics for source and target content as described in FIGS. 4 and 5.

FIG. 4 illustrates the method 400 for processing source content 120 using a topic modeling tool 340 to create a source content-topic matrix 430. The source content is content intended to be ranked and presented to the user. In step 310, the source content 120 is converted (e.g., via the unstructured content conversion tool 211) into a form usable by the topic modeling tool 340, such as via the process described for training content 110 in FIG. 3. The first utilization of the topic modeling tool 340 contains not only the source corpus file 410 and the stop list 330, but additionally the training content dictionary 350. The topic modeling tool 340 generates a source content dictionary 420 based on the training content dictionary 350. The training topic model inferencer 380 is used in concert with the source content dictionary 420 by the topic modeling tool 340 to generate the source content-topic matrix 430. The topic modeling tool 340 processes the source corpus file 410 into topics derived during the training process 300. The source content-topic matrix 430 is a file containing a line for each line of the source corpus file 410. The format is same as described for the training content-topic matrix 370.

FIG. 5 illustrates a method 500 for processing target content 140 using a topic modeling tool 340 to create a target content-topic matrix 530. The target content 140 is content that will provide the basis for ranking source content 120. In step 310, the target content 140 is converted (e.g., via the unstructured content conversion tool 211) into a form usable by the topic modeling tool 340, using the process described for training content 110 in FIG. 3. The first utilization of the topic modeling tool 340 contains not only the target corpus file 510 and the stop list 330, but additionally the training content dictionary 350. The topic modeling tool 340 generates a target content dictionary 520 based on the training dictionary 350. The training topic model inferencer 380 is used in concert with the target content dictionary 520 by the topic modeling tool 340 to generate the target content-topic matrix 530. The topic modeling tool 340 processes the target corpus file 510 into topics derived during the training process 300. The target content-topic matrix 530 is a file containing a line for each line of the target corpus file 510. The format is same as described for the training content-topic matrix 370.

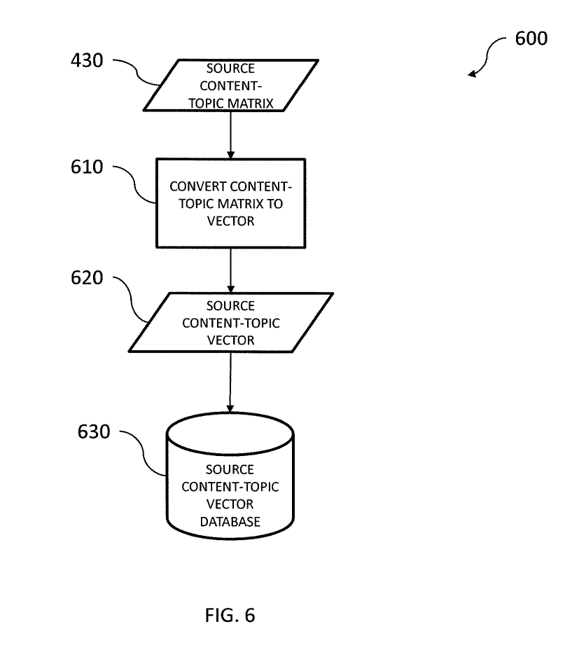

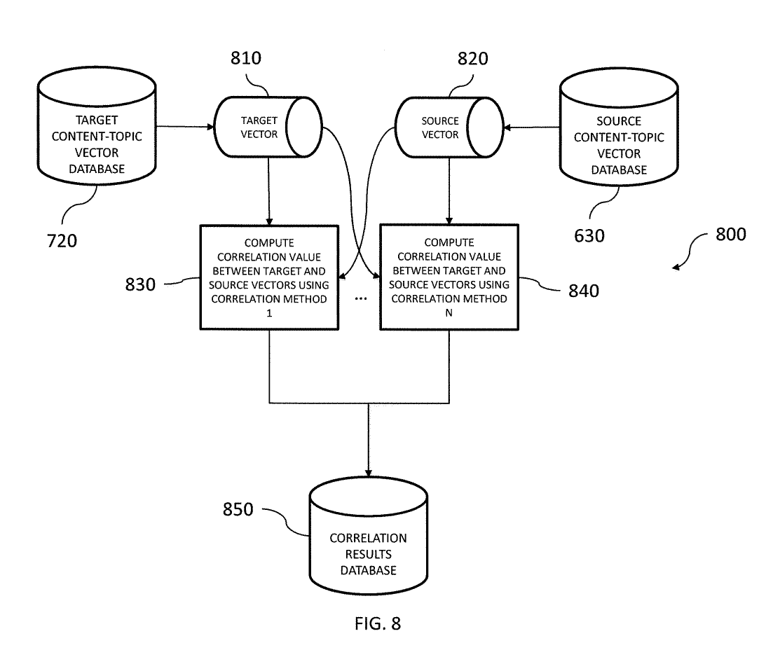

FIG. 6 illustrates a method 600 for processing a source content-topic matrix 430 into a database of source content-topic vectors 630. The source content-topic matrix 430 must first be converted into vector format 610, such as via the content-topic matrix to vector conversion tool 215 of the computing device 202. Each line of the source content-topic vector 620 may contain a vector in numeric order of the topics for each line of the source content-topic matrix 430. The source content-topic vector 620 is then stored in a source content-topic vector database 630. The source content vectors are then retrievable for correlation and ranking against target content vector, such as described in more detail below with respect to the method 800 illustrated in FIG. 8.

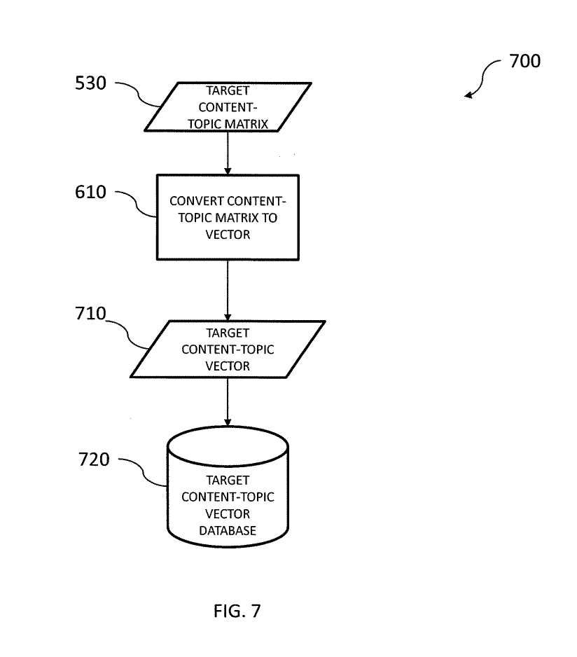

FIG. 7 illustrates a method 700 for processing a target content-topic matrix 530 into a database of target content-topic vectors 720. The target content-topic matrix 530 must first be converted into a vector 610, such as via the content-topic matrix to vector conversion tool 215 of the computing device 202. Each line of the target content-topic vector 710 may contain a vector in numeric order of the topics for each line of the target content-topic matrix 530. The target content-topic vector 710 may then be stored in a target content-topic vector database 720. The target content vector may then be retrievable for correlation and ranking against a similarly processed source content vectors, such as described in more detail below with respect to the method 800 illustrated in FIG. 8.

FIG. 8 illustrates a method 800 for correlating a target content topic vector 810 against a database of source content topic vectors 630. A single target vector 810 is extracted from the target content topic vector database 720 and correlated against a single source vector 820 extracted from the source content topic vector database 630. In step 830, a correlation computation is is run (e.g., via the correlation computation tool 217 of the computing device 202) to compute the correlation value between the single target vector 810 and single source vector 820 using a first correlation method, with the result then stored into a correlation results database 850. A plurality of correlation methods may be computed for each target to source pairing, illustrated in step 840 as the performing of the correlation computation n number of times using n correlation methods. Example correlation methods may include Pearsons, Spearman, Kendall Tau-a and Kendall Tau-b. This method is repeated for one or more source content vectors 820 stored in source content topic vector database 630.

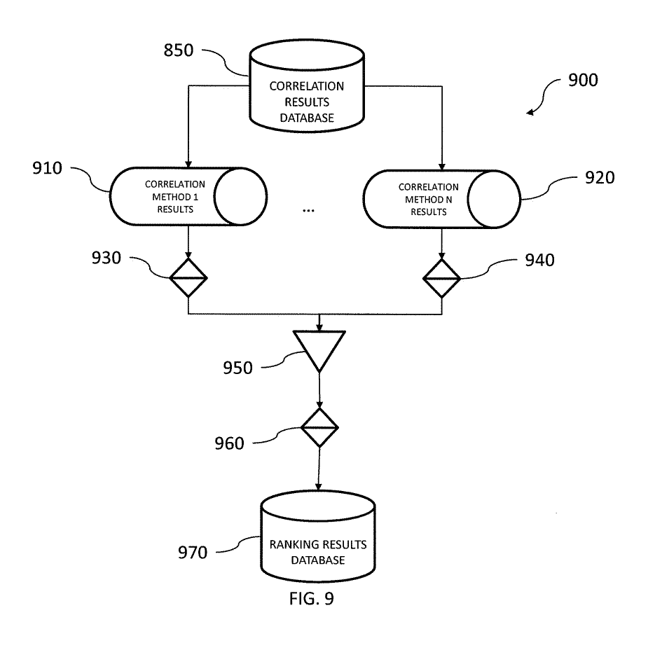

FIG. 9 illustrates a method 900 for combining correlation results from a correlation results database 850 into a ranking results database 970. The correlation results for a single target using a first correlation method 910 are retrieved from the correlation results database 850. The results are the sorted in rank order 930 (e.g., via the ranking tool 218 of the computing device 202). In step 920, the retrieval and ranking of the correlation results is repeated n times, for each correlation method used for the target. The rank for each target source pair is then combined, in step 950 (e.g., via the ranking tool 218). The resulting combined rankings are then sorted, in step 960. The resulting combined rankings are then stored into a ranking results database 970.

FIG. 10 illustrates a method 1000 for incorporating user provided feedback 1010 from the rank list of source content presented to the user 150. After a ranked list of source content is presented to a user 150, the user may optionally choose to provide feedback about the presented sources to improve the target content topic vector 810. A user may identify source content positively or negatively 1010 if they identify source content that correctly or incorrectly ranked to the target content. User provided feedback 1010 is stored into a feedback database 1020 to maintain a record of selections. User feedback is then utilized to compute a new target content topic vector 810 for ranking source content 120 and stored in target content-topic vector database 720. For instance, in step 1030, the feedback vector computation tool 219 of the computing device 202 may compute negative, positive, and weighting vectors based on the user feedback. The negative, positive, and weighting vectors may be used to compute the new target content topic vector(s) 810, which, in step 1040, may be updated accordingly in the content-topic vector database 720.

A plurality of approaches can be applied for utilizing the user feedback that adjusts the target vector 810 to create a new ranking for the source content 120. One embodiment would be to average positive content vectors as a new target vector 810. The ranking process 800 is then executed using the new target vector 810.

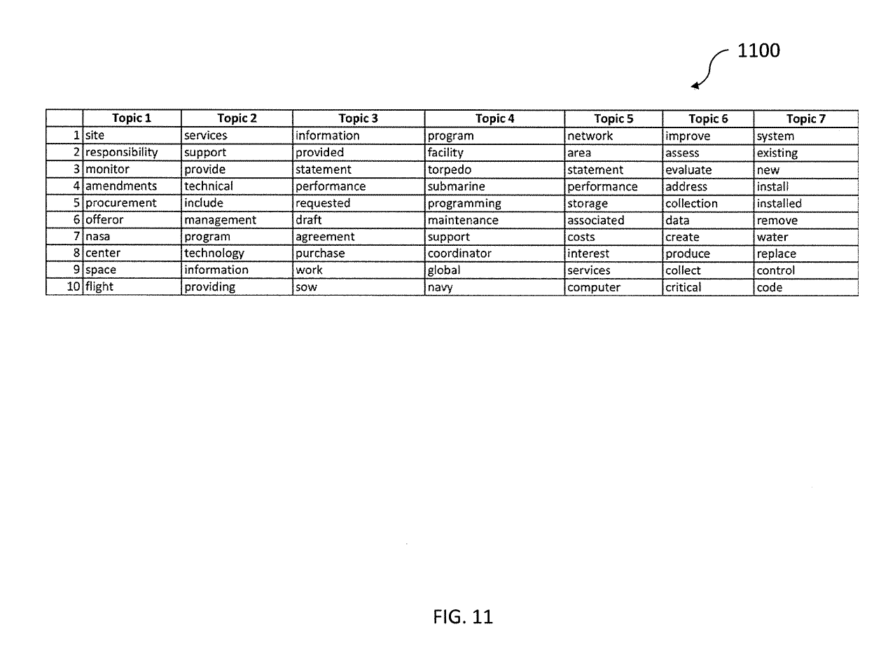

FIG. 11 illustrates an example training topic term matrix 360 as a possible output from the topic modeling tool 340. This example presents seven different topics labeled Topic 1 through Topic 7. The terms in a topic term matrix are listed in probability order from highest probability to lowest. The number of terms included is a parameter to the topic modeling tool 340. Any plurality of topics may be used. Seven topics are provided as an example implementation of at least one embodiment of the present disclosure.

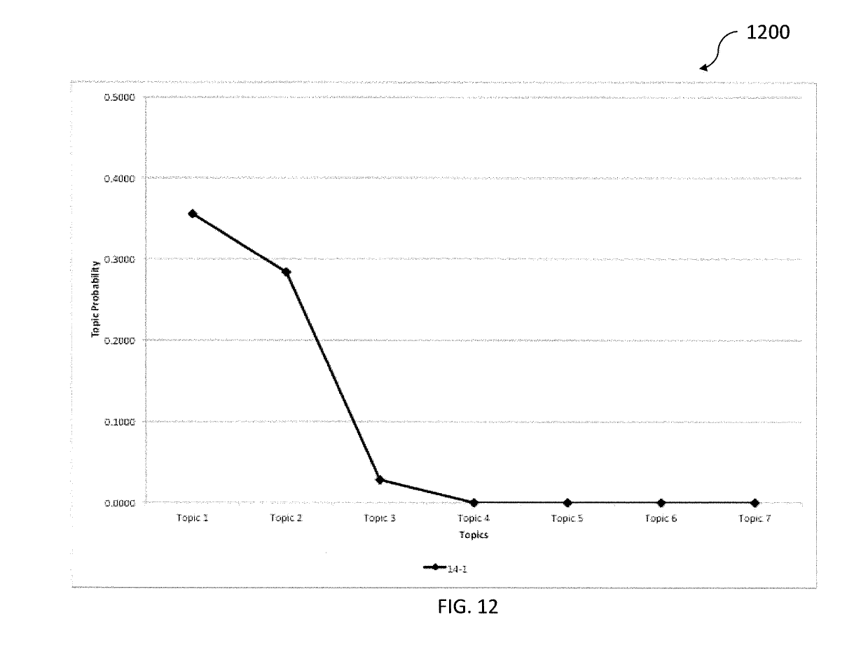

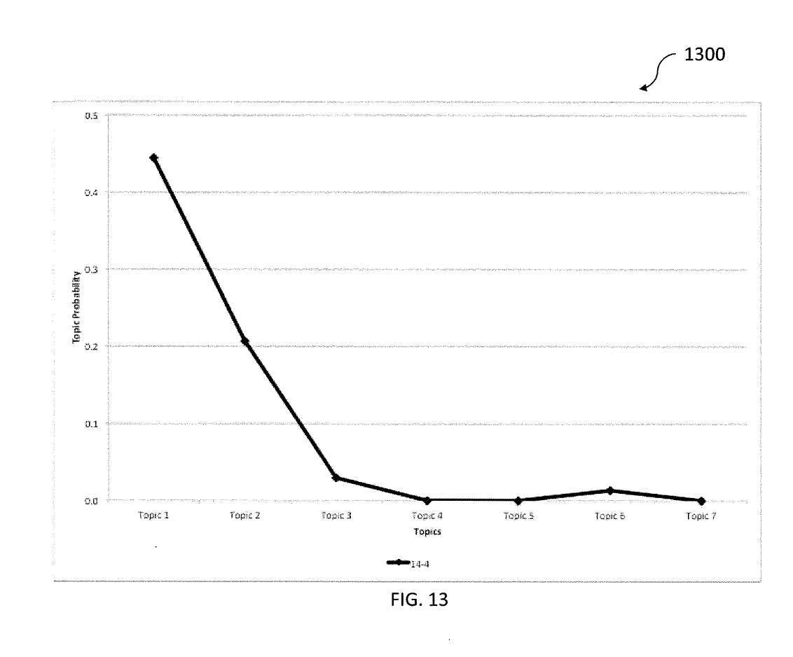

FIGS. 12 and 13 are example graphs 1200 and 1300 illustrating the type of values that may be derived from a content-topic matrix 370, 430, and 530. They also illustrate example target vector 810 and source vector 820 shown in system 800. The topic probability is given on the y axis and the individual topics as described in FIG. 11 are given on the x axis.

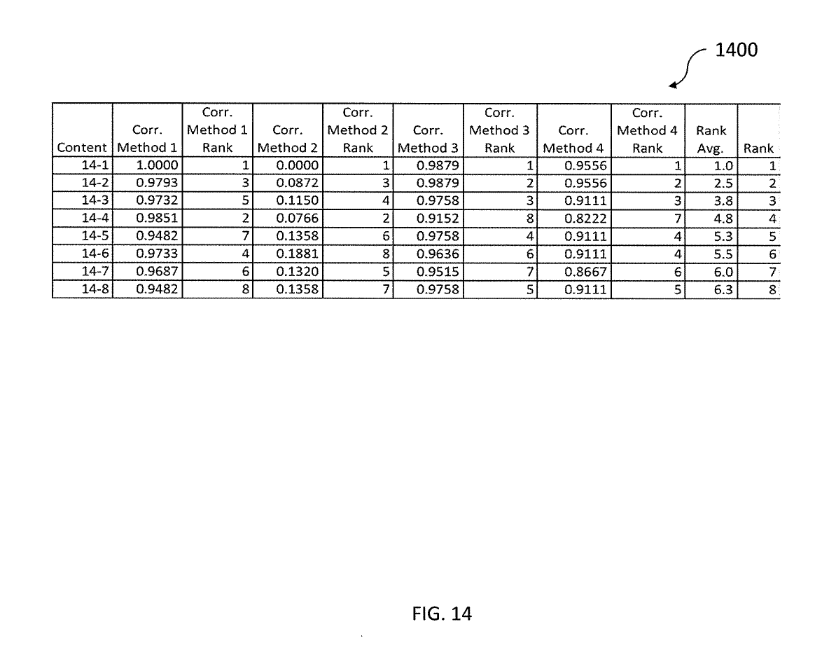

FIG. 14 illustrates an example computation 1400 of system 900, FIG. 9. The first column, “Content,” shows example source vector 820 labels. The second column, “Corr. Method 1,” is an example correlation computation (e.g., performed by the correlation computation tool 217 of the computing device 202) between a target vector 810 and the example source vector 820. The third column, “Con. Method 1 Rank,” is the ranking (e.g., performed by the ranking tool 218 of the computing device 202) of the example source vector 820 based on the results of correlation method 1. The fourth column, “Corr. Method 2,” is an example secondary correlation computation between target vector 810 and the example source vector 820. The fifth column, “Corr. Method 2 Rank,” is the ranking of the example source vector 820 based on the results of correlation method 2. The sixth column, “Corr. Method 3,” is an example tertiary correlation computation between target vector 810 and the example source vector 820. The seventh column, “Corr. Method 3 Rank,” is the ranking of the example source vector 820 based on the results of correlation method 3. The eighth column, “Corr. Method 4,” is an example quaternary correlation computation between target vector 810 and the example source vector 820. The ninth column, “Corr. Method 4 Rank,” is the ranking of the example source vector 820 based on the results of correlation method 4. The tenth column, “Rank Avg.,” is the average of the ranks of correlation method 1 rank, correlation method 2 rank, correlation method 3 rank and correlation method 4 rank. The last column, “Rank,” is the new combined rank derived from sorting the rank averages. The source vector 820 can then be presented to the user in rank order 150. Any plurality of correlation methods may be applied. Four methods are provided as an example implementation of at least one embodiment of the present disclosure.

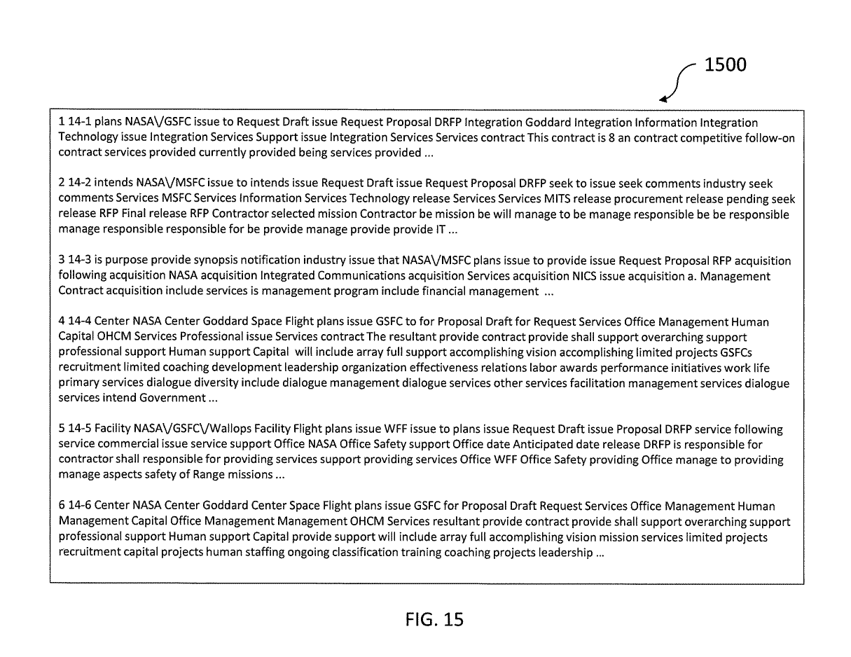

FIG. 15 illustrates an example training corpus file 1500 as a possible output from the conversion of unstructured content into terms 310 and input to a topic modeling tool 340. This example presents six different documents indexed 1 through 6. This example additionally presents labels 14-1 through 14-6 for the documents, such as corresponding to the labels illustrated in FIGS. 12-14. The content illustrated after the document labels are terms output from conversion of unstructured content 310, such as performed via the unstructured content conversion tool 211 of the computing device 202. The number of terms depends on the size of the input content and the conversion method used.

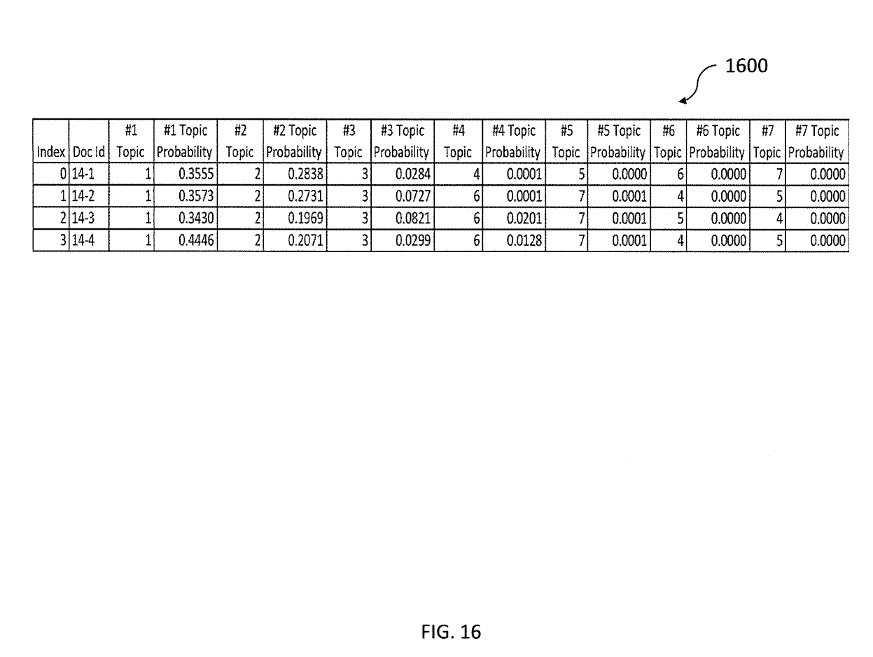

FIG. 16 illustrates an example training content-topic matrix 1600 as a possible output from a topic modeling tool 340.The first column, “Index,” shows an example index for each training content 110 input. The second column, “Doc Id,” shows an example label for each training content 110 input (e.g., corresponding to the labels illustrated in FIGS. 12-15). The third column, “#1 Topic,” is an example first ranked topic number, such as corresponding to the topic numbers illustrated in FIG. 11. Ranking determined by probabilities produced by topic modeling tool 340. The fourth column, “#1 Topic Probability,” is the primary probability of the example content input based on the results of the topic modeling tool 340. The fifth column, “#2 Topic,” is an example second ranked topic number. The sixth column, “#2 Topic Probability,” is the secondary probability of the example content input based on the results of the topic modeling tool 340. The seventh column, “#3 Topic,” is an example third ranked topic number. The eighth column, “#3 Topic Probability,” is the tertiary probability of the example content input based on the results of the topic modeling tool 340. The ninth column, “#4 Topic,” is an example fourth ranked topic number. The tenth column, “#4 Topic Probability,” is the quaternary probability of the example content input based on the results of the topic modeling tool 340. The eleventh column, “#5 Topic,” is an example fifth ranked topic number. The twelfth column, “#5 Topic Probability,” is the quinary probability of the example content input based on the results of the topic modeling tool 340. The thirteenth column, “#6 Topic,” is an example sixth ranked topic number. The fourteenth column, “#6 Topic Probability,”, is the senary probability of the example content input based on the results of the topic modeling tool 340. The fifteenth column, “#7 Topic,” is an example seventh ranked topic number. The sixteenth column, “#7 Topic Probability,” is the septenary probability of the example content input based on the results of the topic modeling tool 340.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method for ranking electronic content, the method comprising:
receiving training content;
receiving source content;
receiving target content;
utilizing topic modeling tool;
translating received content to a topic modeling tool format;
utilizing a topic modeling tool to generate a content-topic matrix based on the translated content;
translating the content-topic matrix to a vector format;
correlating target and source vectors;
merging results from a plurality of correlation methods into a single ranking; and
presenting the ranked results to user.

2. The method of claim 1, wherein said training content is a collection of non-transitory computer readable medium utilized to represent a domain of inquiry for ranking.

3. The method of claim 1, wherein said source content is a collection of non-transitory computer readable medium that will be ranked and presented to user.

4. The method of claim 1, wherein said target content is a non-transitory computer readable medium that externally specifies as content and provides a basis of ranking source content.

5. The method of claim 1, wherein the topic modeling tool is capable of identifying groups of related sub-content from a collection of content.

6. The method of claim 5, wherein said topic modeling tool is capable of identifying groups of related sub-content from content utilizing a pre-existing trained topic model.

7. The method of claim 5, wherein said topic modeling tool is a tool capable of generating a topic term matrix.

8. The method of claim 5, wherein said topic modeling tool is capable of generating a content-topic matrix.

9. The method of claim 5, wherein said topic modeling tool is capable of generating a topic model that can be re-utilized on other related content.

10. The method of claim 1, wherein said converter to translate content to topic modeling tool format is capable of extracting sub-content from content and creating a non-transitory computer readable medium suitable for input into the topic modeling tool.

11. The method of claim 10, wherein said converter to translate content to topic modeling tool format is capable of extracting sub-content from content where contextual relationship between sub-content can be maintained.

12. The method of claim 1, wherein said converter to translate content-topic matrix to vector format is capable of taking a content-topic matrix from the topic modeling tool, creating a topic vector and generating a non-transitory computer readable medium suitable for stored into a database.

13. The method of claim 12, wherein said stored into database is capable of maintaining the relationship between the content, topic number and topic probability.

14. The method of claim 1, wherein said computational capability to correlate target and source vectors is capable of extracting target and source vectors from database of target and source vectors, performing a plurality correlation calculations and storing the correlation results into a database.

15. The method of claim 14, wherein said computational capability to correlate target and source vectors is capable of maintaining a relationship between the target content, source content, correlation method and correlation value.

16. The method of claim 1, wherein said computational capability to merge results from a plurality of correlation methods into a single ranking is capable of retrieving a plurality of correlation results from a database, ranking the results for each correlation method for a target, merging the plurality of results into a single ranking and storing the ranking into a database.

17. The method of claim 16, wherein said computational capability to merge results from a plurality of correlation methods into a single ranking is capable of maintaining the relationship between the target content, source content and rank.

18. The method of claim 1, wherein said presenting ranked results to user is capable of presenting to the user some portion of the ranked results for an externally specified target content.

19. The method of claim 18, wherein said presenting ranked results to user is capable of allowing the user to identifying source content that is a proper or improper match to the target content.

20. The method of claim 19, wherein presenting ranked results to the user is capable of storing user feedback of proper or improperly identified sources into a database.

21. The method of claim 19, wherein said presenting ranked results to user capable of allowing the user to identifying source content that is a proper or improper match to the target content is capable of computing a new target content vector, based on the original target content vector, positive feedback source vectors and negative feedback source vectors.

22. The method of claim 19, wherein said presenting ranked results to user is capable of allowing the user to identifying source content that is a proper or improper match to the target content is capable of re-correlating a new ranked result based on the user feedback.

23. A system for ranking electronic content, comprising:
a processor and a memory, the processor being configured to receive training content;
a translator to convert training content to a topic modeling tool format;
a topic modeling tool to generate a training content dictionary;
a topic modeling tool to generate a training topic term matrix;
a topic modeling tool to generate a training content-topic matrix; and
a topic modeling tool to generate a training topic model inferencer.

24. The system of claim 23, further comprising:
receiving source content;
a translator to convert source content to topic modeling tool format;
a topic modeling tool to generate a source content dictionary utilizing the training content dictionary;
a topic modeling tool to generate a source content-topic matrix utilizing the training topic model artifacts;
a translator to convert a source content-topic matrix to a vector; and
a source content-topic vector database to store relationship between source content and topic vector.

25. The system of claim 24, further comprising:
receiving target content;
a translator to convert target content to a topic modeling tool format;
a topic modeling tool to generate a target content dictionary utilizing the training content dictionary;
a topic modeling tool to generate a target content-topic matrix utilizing the training topic model artifacts;
a translator to convert a target content-topic matrix to a vector; and
a target content-topic vector database to store relationship between target content and topic vector.

26. The system of claim 25, further comprising:
a target content vector retriever to retrieve a target content vector from the target content-topic vector database;
a source content vector retriever to retrieve a source content vector from the source content-topic vector database;
a correlation processer to correlate a target content vector against a source content vector;
an iteration processor to correlate a target content vector against one or more source content vectors; and
a correlation results database to store correlation results between a target content vector and source content vector.

27. The system of claim 26, further comprising:
a correlation results retriever to retrieve correlation results for all sources and correlation approaches for a target content;
a sorting process to rank one or more sources for a target content and correlation approach;
a merging process to combine rankings for all ranked sources and correlation approaches for a target content; and
a ranking results database to store ranking results for all ranked sources for a target content.

28. The system of claim 27, further comprising:
a ranking results retriever to retrieve ranking results for sources for a target content.

29. The system of claim 28, further comprising:
a presentation to a user of ranked source content for a target content.

30. The system of claim 29, comprising:
a feedback identifier to identify source content that is a proper or improper match to the target content capable of adjusting a new ranked result based on the user feedback.

31. The system of claim 30, comprising:
a feedback database to store source content that is a proper or improper match to the target content.

32. The system of claim 31, comprising:
a merge processor for merging the target content vector, positive feedback source vectors and negative feedback source vectors.

33. The system of claim 32, comprising:
a re-ranking processor to re-correlate previously ranked source vectors for the merged target content vector, positive feedback source vectors, and negative feedback source vectors.

34. A non-transitory computer-readable medium having computer-executed instructions stored thereon that, when executed by a computing device, cause the computing device to perform a method for ranking electronic content, comprising:
receiving training content;
receiving source content;
receiving target content;
translating received content to a topic modeling tool format;
utilizing a topic modeling tool to generate a content-topic matrix based on the translated content;
translating the content-topic matrix to a vector format;
correlating target and source vectors;
merging results from a plurality of correlation methods into a single ranking; and
presenting the ranked results to user.
